(19) United States
(12) Patent Application Publication
(10) Pub. No.: US 2008/0028083 A1
(43) Pub. Date: Jan. 31, 2008

(54) Adaptively controlled resource and method for controlling the behavior of same

(76) Inventors: Babak Rezvani, New York, NY (US); Jack L. Chen, Astoria, NY (US)

Correspondence Address: KENYON & KENYON LLP, ONE BROADWAY, NEW YORK, NY, 10004, US

(21) Appl. No.: 11/286,179

(22) Filed: Nov. 23, 2005

Related U.S. Application Data
(63) Continuation of application No. 09/684,013, filed on Oct. 6, 2000, now abandoned.
(60) Provisional application No. 60/230,316, filed on Sep. 6, 2000.

(51) Int. Cl. G06F 15/16

(52) U.S. Cl. 709/229

(57) ABSTRACT

The invention relates to an adaptively controlled resource and method of adaptively controlling resource behavior. An adaptively controlled resource is provided having at least one parameter and at least one attribute. A controller is in communication with the resource for receiving parameters and an attribute. The controller generates at least one output attribute corresponding to the first resource parameters. The controller communicates the output attribute to the resource and one of the at least one parameter of the resource is updated such that the behavior of the first resource is modified in regard to the updated parameter.

### FIELD OF THE INVENTION

The invention relates generally to an adaptively controlled resource and a method for adaptively controlling the behavior of a resource, and more particularly to controlling computer network traffic and data send rates.

### BACKGROUND OF THE INVENTION

The efficient utilization of scarce resources has been a concern since the beginning of civilization. In order to make efficient use of many resources, it is typically necessary to anticipate and quickly respond to changing conditions with respect to the utilization of that resource. This is particularly true in the field of computer networks.

As the multiplicity of Internet applications grows, the number of users transmitting data over the Internet increases, and user's expectation of quality of transmitted data becomes more critical. In addition, new requirements surface for effectively managing the flow of data over the Internet. The TCP protocol was one of the first efforts in this data management goal. Hosts on the Internet today typically transmit data in what is known as a greedy fashion, sending as much data as can possibly fit on the wire. The TCP algorithm, through the use of acknowledgment messages, notifies a sender of successfully received data packets. A sender, not receiving an acknowledgment for packets and also knowing that packets are dropped when a network is too full, gauges how much to slow down its sending rate to reduce overall network congestion and make for better data throughput. Each sender uses its local knowledge about how congested the network is by always pushing the envelope maximum of data through the network.

There is little coordination among senders, and the result is network performance which is often hard to manage and gives less than optimal throughput. In addition, TCP drops packets when the network becomes too full, regardless of the application-specific impacts that dropping such data can have. Applications have no control over what packets are more important than others and cannot effectively tailor their transmission rates to respond to variable network performance. What's more, the TCP transmission characteristics and parameters are hidden from the application in the protocol stack, and information about the current data rate is thus unavailable. The effects are that TCP's inability to coordinate data transmissions from multiple hosts and that TCP's inability for applications to tailor their data transmissions because of the lack of control over TCP's parameters makes for poor network utilization and makes for poor user experiences of the transmitted data.

The RSVP protocol attempts to alleviate many of the quality of service problems inherent in TCP by reserving data throughput at nodes on the intermediate path from sender to receiver within the network. In this scheme, a sender sends as much data as the network can handle, prioritizing the packets in the order of urgency. Each of the receivers propagates a message on the reverse path from the receiver to the sender requesting a specific throughput of data to be set at each intermediate router in the network. An agreed upon amount of throughput is then reserved at these routers, guaranteeing a certain quality of service level along the entire path from sender to receiver.

When data from sender to receiver reaches a router at which the allotted throughput is exceeded, then packets with lower priority are dropped to fit the throughput requirements. The RSVP scheme suffers, however, from a large overhead in the routers that must reserve throughput at the packet level. Packets must be counted and priorities checked at the router, the place where speed is crucial and overhead cannot be tolerated. What's more, receivers and intermediate network service providers do not have a mechanism to notify senders of data throughput ceilings. Senders continue to flood the network with packets, subject only to the greedy TCP protocol back-off due to excessive congestion. Applications continue to lack the vital data throughput requirements that they need in order to make critical data encoding and data prioritization choices to provide receivers with the best quality of data at the current data throughput level.

Thus, from examining available methods, it is clear that a scheme for effectively managing data throughput in a network with multiple senders is necessary that both requires little or no overhead in the network itself and notifies a sender of data requirements so that a sender may make application-specific changes to maintain the highest perceived quality of service as possible.

### SUMMARY OF THE INVENTION

The invention relates to an adaptively controlled resource and method of adaptively controlling resource behavior. An adaptively controlled resource is provided having at least one parameter and at least one attribute. A controller is in communication with the resource for receiving parameters and an attribute. The controller generates at least one output attribute corresponding to the first resource parameters. The controller communicates the output attribute to the resource and the at least one parameter of the resource is updated such that the behavior of the first resource is modified in regard to the updated parameter.

The attribute received by the controller may come from the resource or may be external to the resource. In one embodiment, the resource has a user interface and is updated when the resource is updated. The resource may be a plurality of resources and the controller controls each of the resources. Alternatively, there could be a plurality of the controllers, each associated with at least one of the resources. In one form of the invention, the resource and the controller communicate over the global computer network.

In one embodiment, the resource is a data rate of a client on a computer network and the controller is part of a server on the computer network.

### BRIEF DESCRIPTION OF THE DRAWINGS

For a more complete understanding of this invention, reference should now be made to the embodiment illustrated in greater detail in the accompanying drawing and described below. In the drawings:

FIG. 1 is a schematic view of a first preferred embodiment of an adaptively controlled resource in accordance with the present invention.

FIG. 2 is a schematic view of a second preferred embodiment of an adaptively controlled resource in a computer network environment in accordance with the present invention.

FIG. 3 is a schematic view of a third preferred embodiment of an adaptively controlled resource in a computer network environment accordance with the present invention.

FIG. 4 is a schematic view of a fourth preferred embodiment of a adaptively controlled client-server network resource in accordance with the present invention.

FIG. 5 is a schematic view of the client and server components of the system shown in FIG. 4.

FIG. 6 is a schematic view of the controlled devices and virtual representation of same in the server database of the system shown in FIG. 4

FIG. 7 is a simplified schematic representation of a client server system of FIG. 4.

FIG. 8 is a graph depicting the data limits for each client according to the invention of FIG. 4.

### DETAILED DESCRIPTION OF THE PREFERRED EMBODIMENT

The invention relates to an adaptively controlled resource and a method for adaptively controlling the behavior of a resource. Since the inventive concepts apply to many varied technologies, the invention is described in four separate embodiments, each with sufficient implementation to convey the relevant concepts. The first embodiment describes the invention broadly as it applies to any generic technology. The other three embodiments describe the invention in the context of a computer network, but it should be understood that the present invention is equally applicable to any related field of endeavor.

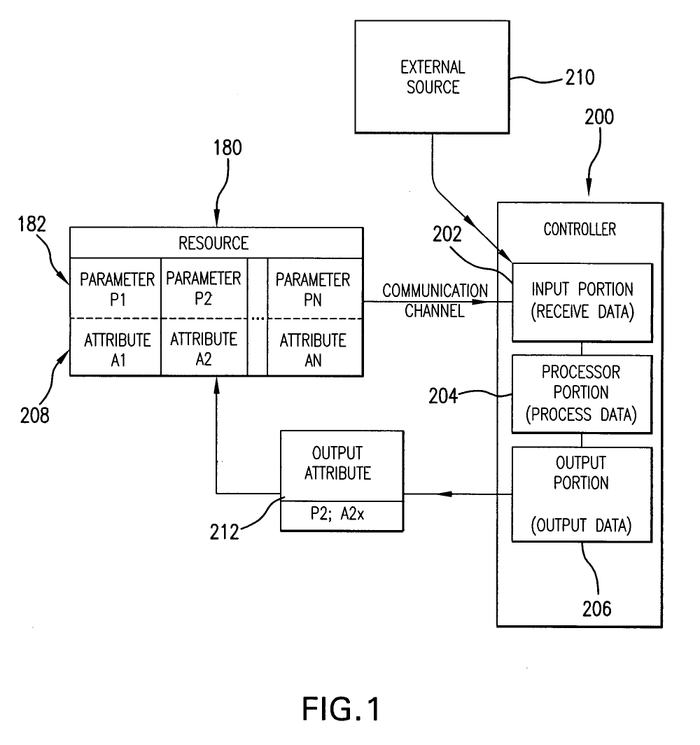

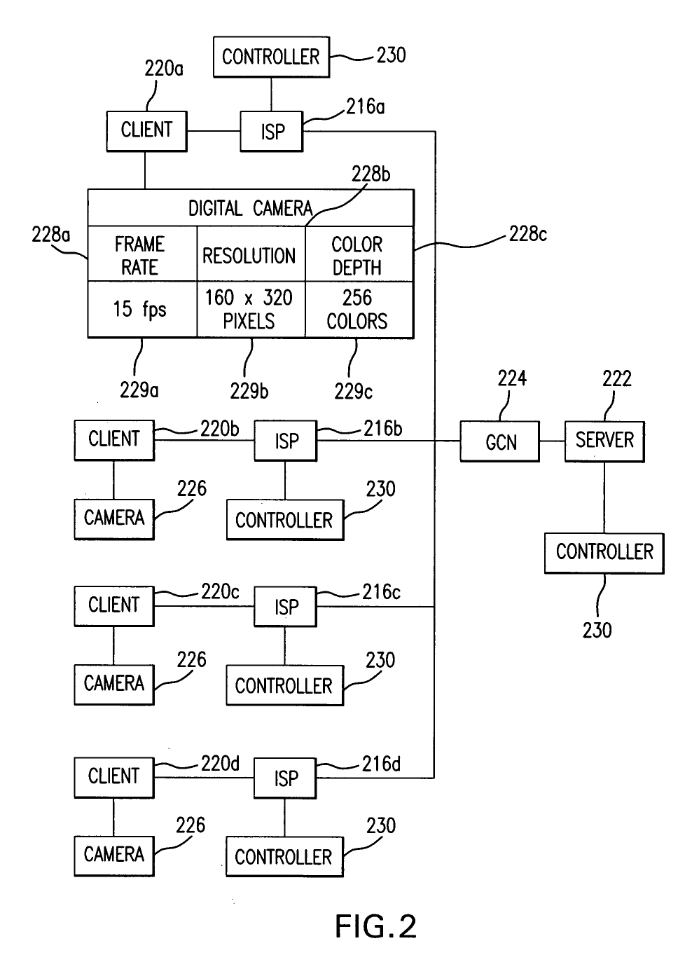

In FIG. 1, there is shown a first preferred embodiment of an adaptively controlled resource or intelligent network device 180 in communication with a controller 200. The resource 180 includes adjustable or modifiable parameters 182 that collectively define the behavior of the resource. The current state of a particular parameter is defined as an attribute of the resource. For example, if the resource were a digital video camera, the parameters of the camera would include the frame rate, the resolution, and the color depth of the digital video, and the attributes of each parameter at a particular point in time could be 15 fps, 160×320 pixels, and 256 colors, respectively. Such a video camera resource 226 is depicted in FIG. 2 having parameters 228 and parameter attributes 229.

A resource is defined as any source of supply, support, or capabilities that can be controlled or whose behavior can be modified. Some examples of a resource include computer network access; the capacity of waste water or sewage process or outlet pipe; the electrical generating capacity of a power plant on a shared electrical grid; the speed of a motor vehicle traveling on a path, road or public highway; a household appliance such as an oven, refrigerator, washing machine, lamp or the like; and an electronic device, such as a video camera, video or audio recorder, a radio, or the like.

A resource parameter is defined as a quality or characteristic of the resource that is adjustable, modifiable, and/or controllable. Some examples of resource parameters include the data rate of a client on a computer network, the flow rate of a chemical in a chemical process, the electrical output of an electrical generating plant, the speed of a motor vehicle, the frame rate of a digital video camera, and the like.

The behavior of a resource is modifiable by adjusting the attribute or value of at least one of the resource's parameters, modifying the allowable range of the one or more parameters, and/or changing the user's access to the parameter. For example, referring to the video camera in FIG. 2, the behavior of the camera may be changed by reducing the frame rate from 30 fps to 15 fps, changing the range of resolutions from 1024×768-160×120 to 320×240-160×120, or by taking away the user's ability to control the color depth of the video.

An example of a similar resource is shown in the series of screenshots included in the Appendix of this application. Screenshot one shows the resource of a remotely controlled digital camera and its control interface. Screenshot two shows a virtual representation of the camera and interface as accessed from a remote client computer. Screenshot three shows the control screen for the camera of the virtual representation with its brightness parameter being decreased from a first attribute to a second attribute. The fourth screenshot shows the result of this change in brightness parameter attribute on the camera interface. (The parameter change is sent as a poll from the camera control to the server which updates the camera's brightness setting, as best described in the fourth embodiment). The fifth screenshot shows the updated camera view on the virtual representation after the brightness parameter has been changed.

Referring back now to FIG. 1, the controller 200 is used to control the behavior of the resource 180. The controller 200 may be located at a central or remote location, such as on the server on a client-server network, or may be present at the resource itself, such as on the client on a client-server network. The controller 200 is in communication with the resource 180, either in continuous communication or in non-continuous communication, such as in a signaling environment. It is necessary for the controller 200 to have sufficient communication with the resource such that data can be passed from the controller 200 to the resource 180 to effect a change in behavior of the resource, or, if necessary, to pass data or attributes from the resource 180 to the controller 200, as explained below.

The controller 200 functions to receive or measure factors or inputted data 202 either from the resource 200 itself or from other external sources such as a timer, a temperature probe, another resource, or the like; process the inputted data 204, and output data 206 based at least in part upon the result of processed input data. The controller 200 may use any suitable internal or external means to process the data it receives such as by running an algorithm whose variables are based on the inputted data, by consulting a look-up table using the inputted data as a reference, by using an inference engine that uses the inputted data to calculate the result, or the like.

In operation, the input portion 202 of the controller 200 receives inputted data or attributes 208 from the resource 180 and/or other external sources 210. The processor portion 204 processes this inputted attribute and generates an output attribute 212. The output portion 206 of the controller 200 transmits the output attribute 212 to the resource 180 along with an identification of the resource parameter that the attribute or data it is intended to update. The identified resource parameter 182 is updated with the output attribute 212 and the behavior of the resource 180 is adaptively modified thereby. It should be understood that the output attribute may be different from any of the inputted data or attributes.

A second preferred embodiment of the present invention is illustrated in FIG. 2. This second preferred embodiment is a simplified version of the third and fourth embodiments described below. This second embodiment is provided to illustrate how the broad inventive concept is described in connection with FIG. 1, can be used to adaptively control the data rate of a client (the resource).

A plurality of clients 220a-d are connected to a server 222 via a global computer network 224. Each client accesses the global computer network 224 via an Internet service provider or ISP 216a-d, respectively. Each client has an associated digital video camera resource 226 having a plurality of modifiable parameters 228, including a frame rate parameter 228a, a resolution parameter 228b, and a color depth parameter 228c. The current attributes for the parameters are designated by reference numerals 229a, 229b, and 229c, respectively. The ISPs 216a-d and the server 222 are each provided with a controller 230 for the camera resource.

In operation, each client 220a-d is connected to the server 222 via the global computer network 224 by its associated ISP 216a-d. Each client's camera 226 is streaming digital video to the server 222 at a preselected frame rate, resolution, and color depth, resulting in a particular amount of data streamed at a particular data rate. At a preselected time interval, each camera 226 transmits its parameters 228 to its associated ISP controller and the server controller 230. The controllers 230 receive the camera parameters in the form of inputted parameters which are processed by the controller 230 using an algorithm that determines the maximum allowable data rate for all clients and partitions out a data rate limit to each client 220a-d that each client must conform to. For example, if the maximum allowable data rate were 40 MB/sec, the controller could set all four clients' data rate to 10 MB/sec. Of course, the controller 230 could receive inputted parameters and attributes from sources external to the camera resource 226 either in addition to or in lieu of the camera resource's 226 parameters and attributes.

The controller 230 could output this data rate limit to each client in many different forms. The data rate could be transmitted as an output attribute directly to each camera and the camera could modify its frame rate parameters, resolution parameter, and/or its color depth parameter according to a particular optimization algorithm to fall within its data rate limit assigned by the controller 230. Alternatively, a particular frame rate attribute, resolution attribute, and/or color depth attribute could be outputted to each camera and used to update each associated parameter of the camera to fall within the assigned data limit.

In another alternative, the controller could limit the range of each camera's parameters so that no combination of the parameters could result in a data rate above the assigned limit. For example, the available frame rate of a particular camera could be lowered from a maximum of 30 fps to a maximum of 15 fps.

In another alternative, the controller could set two of the parameters to a particular unalterable value or attribute in order to limit the client's data rate and effectively remove the associated controls from the user interface of the client. For example, the controller could pass data to the camera instructing it to set the frame rate at 15 fps, removing this control from the camera. The user would then only be able to modify the resolution and color depth of the streamed video, assuming that no combination of resolution and color depth at this frame rate is capable of exceeding the maximum data rate limit imposed.

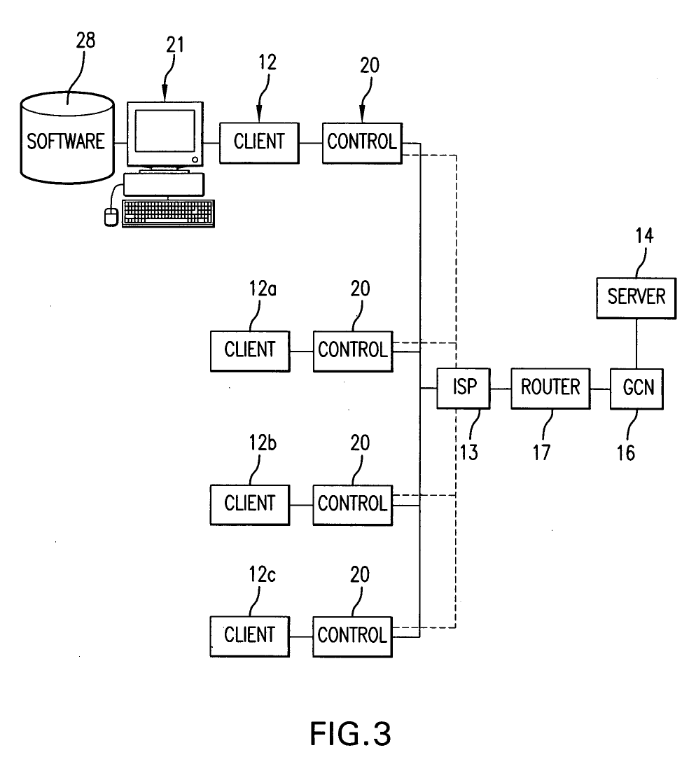

A third preferred embodiment of the present invention is depicted in FIG. 3. In this third embodiment, additional detail is provided relating to a large computer network or WAN, such as a global computer network. The third preferred embodiment illustrates how the control mechanism can be implemented by various elements in the network to provide better control of the client or resource. In particular, this third embodiment illustrates how the concepts of the present invention overcome the deficiencies of typical existing computer networking protocols, such as TCP. In the third preferred embodiment, there are four main entities: a client 12, a server 14, a network service provider 13, and a router 17. The client 12 is connected to a global network 16 through the network service provider 13. After connecting to the global network 16, the client's data must be sent through the router 17 in order to be appropriately routed to the server 14.

A plurality of additional clients 12a, 12b, and 12c may also be connected through the network service provider 13. The present invention contemplates various network topologies such as additional clients 12, additional network service providers 13 connecting the various clients to the global computer network 16, various configurations of routers, bridges, switches and the like to route data from the clients 12 to the server 14, and/or additional servers 14 each having a subset of clients 12 connected thereto.

As shown in FIG. 3, the client 12 is a computer 21 running software 28 which is sending data from the client 12 to the server 14. Other forms of clients would also be suitable for the present invention, such as a networked appliance, a cellular phone, or the like.

The client or resource 12 exports the functionality of a control or controller 20 to outside entities that allows those entities to manipulate the data rate output by the client 12. Many different forms of the control 20, the method of exporting the control, and the method of manipulating the control to effect the data rate change on the client are suitable in addition to the preferred implementation described below.

Because the system of the present invention contains a number of clients 12a-c, each with potentially large amounts of data to send through the service provider 13 to the server 14, it is clear that a coordinated, application-aware method for efficiently managing data flow is necessary. Utilizing the TCP protocol does not adequately address the problem due to the greedy nature of the algorithm which results in an unpredictable and intermittent loss of data due to network over-utilization.

The addition of new clients to the network, each having the potential of sending a large amount of data, is typically not performed easily because it takes a certain amount of time for the new client to become adapted to the network traffic characteristics using its greedy algorithm, negatively affecting all other clients on the network. In addition, neither the service provider 13 nor the individual clients has the ability to coordinate with the other clients to apportion data throughput in such a way that the most fair use of network bandwidth is achieved. Also, network service providers do not possess the ability to tailor data send rates to fit policies determined by the data throughput that is dynamically allotted to a client. Furthermore, applications running on clients using the TCP protocol for data rate management, do not have access to the dynamically changing data rates in order to best present the receiver with intelligible, useful data at the currently given data rate.

Using RSVP, data throughput at the intermediate nodes is reserved and the data is guaranteed to make it through, given that the client follows the minimum data rate requested by all of the receivers and accepted by the intermediate nodes in the network. The drawbacks of RSVP, however, are that intermediate nodes, including the service provider 13, must implement the RSVP scheme, set up guaranteed data throughput channels, check all packets for appropriate priorities, and count all packets to make sure that packets from a given sender fit into the allotted data channels. All of this overhead reduces network performances because the calculations must be performed at the most crucial components in the network, at the routers. In addition, since routers are generally dedicated to forwarding packets as fast as possible, loading them with additional functionality typically deteriorates network performance. Furthermore, RSVP provides the client with little useful knowledge about the upper limit on data rates so that clients cannot conform their data rates to fit under the cap reserved throughout the network. The result is continued network over-utilization and dropped data.

The third preferred embodiment presents authorized nodes in the outside network with a virtual data rate control 20 that can be manipulated. The client that this virtual data rate control 20 is associated with will comply with the upper limit that this virtual control is set to, giving outside entities, such as the service provider 13, the ability to coordinate data rates. In such a scheme, a service provider 13 can limit all data rates of clients 12a-c to be a portion of the total data throughput of the service provider to guarantee that the data will indeed not be lost during transit. Applications running on clients 12a-c will be able to query the data rate control locally to determine how best to present the data at the data rate allotted to the client. In addition, it is planned that the service provider as well as other network nodes can use any conventional collaborative scheme to coordinate to set the client's data rate.

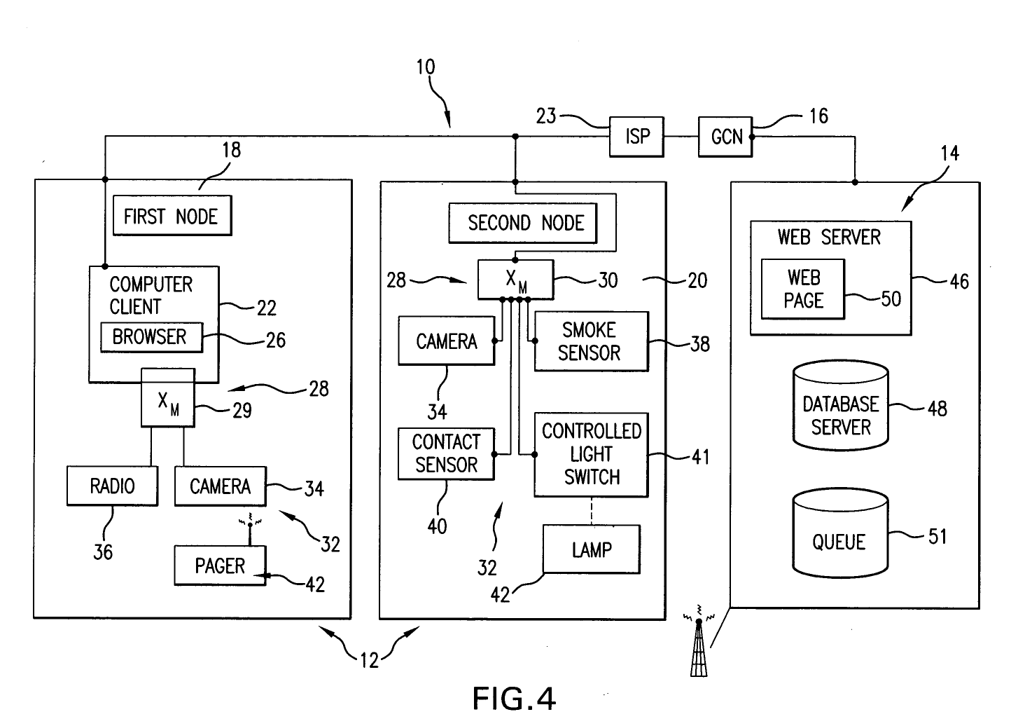

A fourth preferred embodiment is depicted in FIGS. 4-8. This fourth embodiment describes one specific implementation of the present invention in detail to illustrate how the concepts of the present invention overcome the problems of efficiently controlling the data send rates of multiple clients in a client-server specific network.

In FIG. 4 there is shown a client and server system 10 in accordance with the present invention. The client server system 10 includes a client 12 and a server 14 which are connected via a global computer network 16, such as the Internet.

The client 12 is operated by a local user (not shown). The client 12 may comprise a plurality of nodes, such as first user node 18 and second user node 20. It should be understood that the nodes 18 and 20 may be located at a single location, such as the user's house or at separate locations such as the user's main house and the user's vacation house. The present invention contemplates a plurality of local user locations and/or a plurality of remote user locations.

In one form of the invention, the user node 18 includes a client computer 22 that is connected to the global computer network 16 via an Internet Service Provider (ISP) 23 by any conventional means, such as a dial-up connection, DSL line, cable modem, satellite connection, or T1 line. The client computer 22 includes an Internet browser program 26 for accessing web pages via the global computer network 16.

A monitoring module 28 is also provided which serves as a gateway between the server 14 and at least one connected device 32. The monitoring module can take various forms, such as a software program 29 running on the client computer (as shown at node 18). Alternately, the monitoring module 28 can take the form of a stand-alone appliance 30 (as shown at node 20) which is connected to the global computer network 16 and operates separately and independently from the client computer 22. The monitoring module 28 is described in greater detail below.

At least one, and preferably a plurality of, device or appliance 32 is connected to and controlled by each monitoring module 28. The connection between the monitoring module 28 and the various devices 32 can be wired or wireless.

The appliances 32 encompass a multitude of devices which are capable of being controlled or mediated by an external controller. Such appliances include camera 34, radio 36, smoke or fire detector 38, contact sensor 40, and light switch 41. Although not illustrated, it should be understood that the present invention encompasses many other such devices such as various audio input and output devices, various visual displays, washers/driers, microwave ovens, cooking ranges, car alarms, plant watering devices, sprinkler, thermostats, carbon monoxide sensors, humidistats, rain gages, video cassette recorders, radio tuners, and the like.

In addition, a myriad of notification devices, such as pager 42, can also be incorporated into the system. As best seen in FIG. 4, pager 42 is in wireless communication with a wireless or cellular transmitter 44 associated with the server component 14. Other notification devices besides the pager 42 are also contemplated by the present invention including, e-mail clients, wireless hand-held computers, wireless wearable computer units, automatic web notification via dynamic web content, telephone clients, voice mail clients, cellular telephones, instant messaging clients, and the like.

All of the various types of devices set forth above appear to the network as intelligent. So called intelligent devices have one or more of the following characteristics; they have the ability to describe their characteristics either proactively or reactively; they are self announcing to other devices or have the ability to announce for other devices on a network; they have the ability to make decisions about their behavior based on internal and external factors; they have user interfaces which may be adapted or modified in response to internal or external factors; the functionality of the device may change based on the absence or presence of other devices on the network, as shown by the examples and embodiments as discussed herein.

The server 14 of the present invention includes a web server 46 and a database server 48. The web server 46 generates static web pages and dynamic web pages from data contained in the database server 48. The web pages 50 can be viewed by the user on the Internet browser 26 running on the client computer 22.

It is contemplated that the client 12 and the server 14 communicate over the global computer network 16 via the conventionally available TCP/IP environment using the HTTP protocol. Of course, it should be understood that any request-response type of protocol and socket-based packet transport environment would also be suitable and within the scope of the contemplated invention.

It is also contemplated that the server 14 of the present invention functions as the master controller of the system 10. In addition, the client-server configuration of the system 10 and the connection of the system 10 to the global computer network 16 via an ISP 23 allow a user to access the system 10 via any computer, monitoring appliance or similar device connected to the global computer network 16.

In this way a user is able to control and monitor a plurality of devices 32 connected to the monitoring module 29 at node 18 and a plurality of devices 32 connected to the networked monitoring module 30 at node 20. The devices 32 can be accessed via any personal computer 22 by accessing the control server 14 via the global computer network 16. By using a global computer network 16 it should be clear that a user, or anyone the user permits access to, can readily monitor and control the monitoring modules 28 at nodes 18 and 20, from any location, using any suitable device that has access to the global computer network 16.

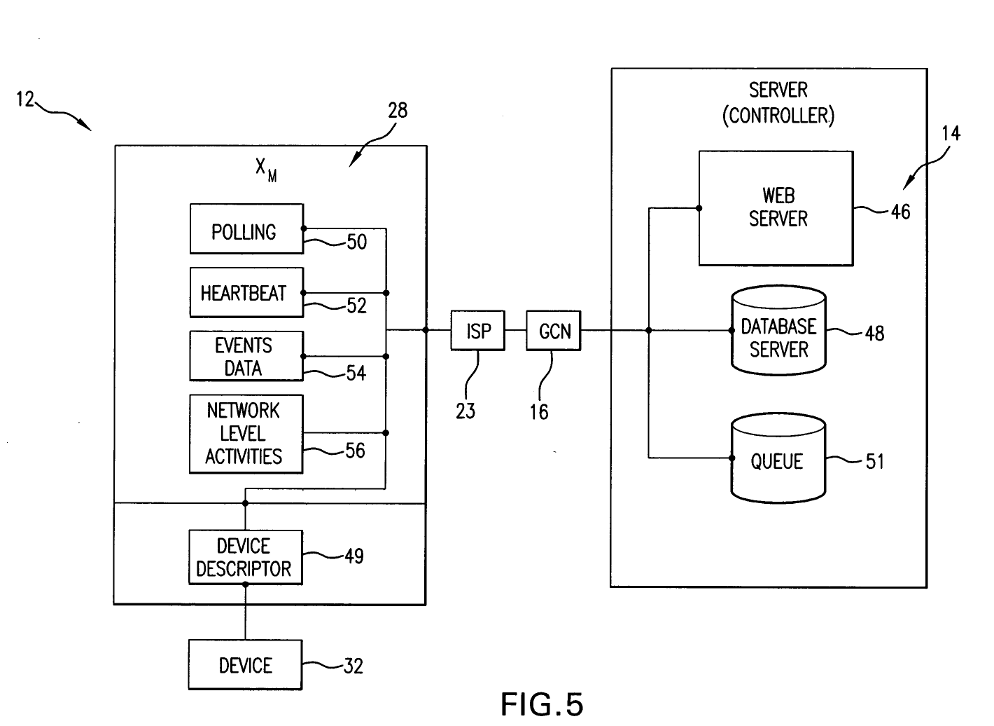

Referring now to FIG. 5, the monitoring module 28 serves as the connection hub for the controlled devices 32 and as the gateway for brokering communications between the devices 32 and the control server 14 via the global computer network 16.

One of the functions of the monitoring module 28 is to serve as a translation and brokering agent between the server 14 and the connected devices 32. In its software form 29, the monitoring module 28 comprises a plurality of dynamically loaded objects, or device descriptors 49 that allow the server 14 to interface with the connected devices 32. The dynamically loaded device descriptors 49 act as the device drivers for the connected devices 32, translating, in both directions, the monitoring, command, and control data sent and received from the monitoring module 28 to the server 14 via the global computer network 16. Each device descriptor 49 also translates the signals received from the monitoring module 28 into the specific electrical signals that are required to communicate with, both input and output, and control its associated device 32. In addition, because each device 32 has its own specific interface and requires a specific set of electrical signals to monitor and control it, a different device descriptor 49 must be provided for each specific model of each device 32.

The monitoring module 28 also controls the communication between the server 14 and the connected devices 32 via the global computer network 16. The HTTP protocol employed by the existing global computer network is a stateless protocol. Since the knowledge of the current state of the connected devices is vital to the successful operation of the system 10, it is necessary for the monitoring module 28 to store the persistent state of the connected devices 32 and to provide a system for periodically updating and obtaining the state of each connected device 32 and for obtaining commands from the server 14. The monitoring module 28 does this by polling 50 the server 14 and maintaining a system heartbeat 52.

The monitoring module 28 polls 50 by scheduling a transmission between the monitoring module 28 and the server 14 in which it checks for commands from the server 14. If commands are waiting on the server 14, the server will return commands in an algorithmic manner, that can take various forms, for processing and also informs the monitoring module that N commands are waiting in the queue. The monitoring module 28 will then poll the server 14 and retrieve data from the server 14 until there are no more commands in the queue. In this way commands from the server 14 can be delivered to the monitoring module 28 to effect changes in the devices 32 over the stateless medium of the existing global computer network 16.

In a typical polling operation 50, the client computer 22 issues a command for incurring a change in state of one of the controlled devices 32. The change in state command is posted to a data store 51, such as a command queue associated with the server 14. Similarly, if the server 14 desires to make an internal change to the monitor 28, such as setting or modifying the polling 50 or heartbeat 52 time intervals, these commands are likewise posted to the storage device 51. Upon reaching the end of the current polling interval, the monitoring module 28 sends a transmission to the server 14, requesting any queued commands. The monitoring module 28 continues to poll, using a preselected transmission scheme, until the queue of commands waiting for the monitor 28 is complete. Each command received from the queue is acted upon when it is received and any associated state changes are effected. The server 14 transmits an acknowledgment of receipt and successful processing of the data back to the monitoring module 28.

The monitoring module 28 is also responsible for maintaining a heartbeat 52 or a scheduled periodic update regime to refresh the current state of the devices 32 stored in the database server 48. The primary function of the heartbeat 52 is to synchronize the states of the devices 32 and the virtual representation of those devices stored on the server 14. The heartbeat 52 also functions to send device events and state changes between the devices 32 and the server 14 to effect this synchronization of the control server 14 and to assure that the monitoring module 28 and the server 14 are synchronized.

Not only is the monitoring module able to send commands to the server 14, but the server 14 is able to send commands back to the monitoring module 28. The types of transmissions that cause the server 14 to send unsolicited transmissions back to the monitoring module 28 are to set or update the heartbeat or polling time and to issue a command to update a component of a device.

In a typical heartbeat operation 52, the monitoring module 28 sends a transmission to the server 14 in response to a change in state of a connected device 32, a synchronization of a control device 32 with server 14, a triggered alert event, or the like. In such a heartbeat operation 52, all data intended to be transmitted to the server 14 is transmitted to the server 14 via the global computer network. The server 14 transmits an acknowledgment of receipt and successful processing of the data back to the monitoring module 28.

Along with maintaining the polling and heartbeat operations and sending and receiving events, data, and commands 54 to and from the server 14, the monitoring module 28 also takes care of many network level activities 56 such as verifying passwords, dialing up the ISP if necessary, periodically uploading accounting/billing information, and performing security measures.

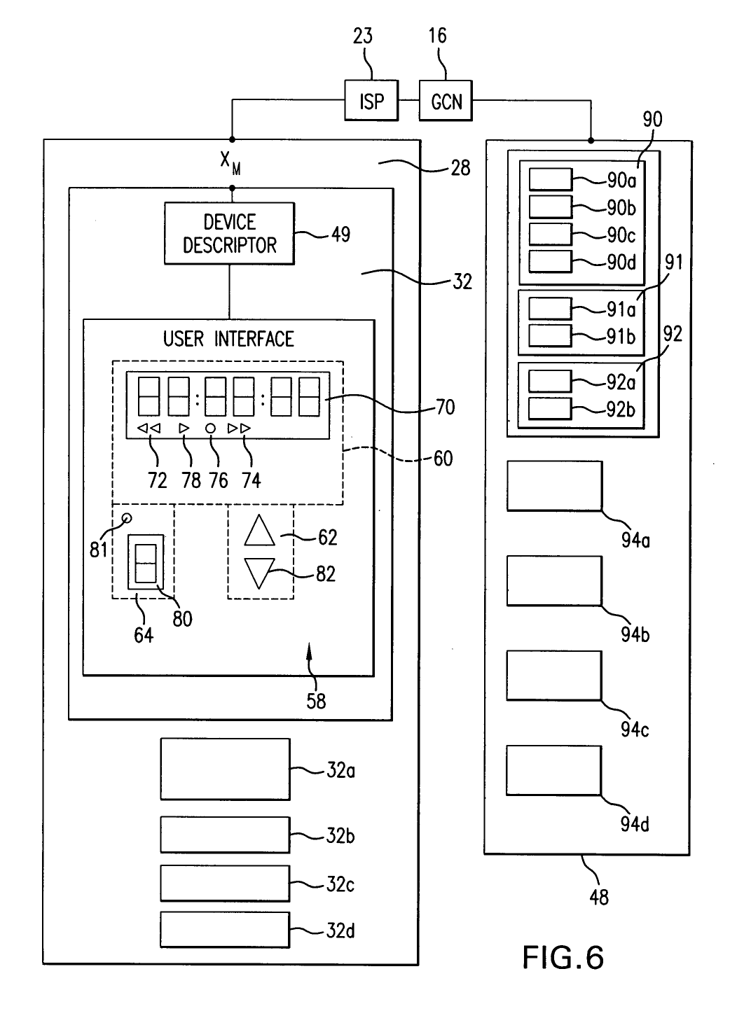

Another function of the monitoring module 28 is the storage of the persistent state of the devices 32. In the event that the user's computer 22 crashes and the monitoring module 28 must be restarted, many of the parameters that were negotiated between the monitoring module 28 and the server 14 during the registration process are stored in the memory of the monitoring module. Referring now to FIG. 6, a series of devices 32, 32a, 32b, 32c, 32d is shown. Each device is connected to a monitoring module 28 via a device descriptor or driver 49 (only one shown). Each device includes a customizable user interface 58 that is viewable on the client computer 22 over the global computer network 16 through a virtual representation of the user interface stored on the web server 46, as explained below. The user interface 58 comprises at least one resource or sub-devices 60, 62, and 64. Typically, a resource provides a specific functionality of the device. For example, the device shown in FIG. 6 represents a VCR having a recording setting resource 60, a channel selecting resource 62, and a power selecting resource 64. Of course, a typical VCR would have many other operational resources, but the resources illustrated are sufficient to describe the basic operation of the device.

Each resource 60, 62, 64 is made up of components or the basic building blocks of the user interface 58 of the device. For example, the recording setting resource 60 comprises a display component 70 and a series of pushbuttons 72, 74, 76, 78 which activate the VCR's fast forward, reverse, play, and stop functions, respectively. The channel selecting resource 62 comprises the display component 70 and a pair of pushbuttons 82 which activate the up channel and down channel functions of the VCR. The power selecting resource 64 comprises a toggle switch 80 for activating the VCR's power on and power off commands and an LED indicator 81 which indicates the power condition of the VCR.

A virtual representation of each device 32, 32a, 32b, 32c, 32d also exists as a record 94, 94a, 94b, 94c, 94d in the database server 48 of the control server 14. Each record contains an entry for each resource and its associated components which make up the device. For example, The record function 94 for the VCR device 32 contains an entry 90, 91, 92 for each resource 60, 62, 64 and an entry 90a, 90b,90c,90d, 91a, 91b, 92a, 92b for each component 70, 72, 72, 74, 80, 81, 82, respectively. In addition, a web page 50 can be generated by the web server 46 by extracting the associated record for that device from the database server 48 and creating a graphical, textual, tactile, aural, or other similar modality user interface representation of that device which a user can access via the Internet browser 26.

In operation, the client 12 first registers with the server component 14 to begin using the services offered therein by accessing the web server 46 of the server component 14 via the client browser 26. At this point, an account is opened for the client 12 and the user's information is stored in the database server 48. If it has not been previously registered, the monitoring modules 29 and 30 would also be registered with the server component 14 and their information would also be stored in the database server 48 and associated with the node 18. Once the monitoring modules 29 and 30 have been registered, any device 32 that is attached to either of the monitoring devices 29 and 30 would also be registered in the system, stored in the database server 48, and available to the user. Each device 32 communicates with the monitoring modules 29, 30 and either exports its interface to the database server 48 or otherwise obtains a default interface configuration, as explained in greater detail below. These interfaces, as described in greater detail below, are adapted to be displayed, to be viewed, and to be interacted with by the user via the client browser 26 over the global computer network 16 by accessing the web server 46.

A few uses of the present system 10 will now be explained to aid in the understanding of the operation. For example, the contact sensor 40 could be associated with the front door (not shown) at the remote location 20 and set to trip whenever the front door is opened. The camera 34 is also positioned to view the front door location and can be programmed to take a digital photograph whenever the sensor contact 40 is tripped and transmit that photograph to be stored in the database server 48. When, in fact, the contact sensor 40 detects that the front door has been opened, an event notification or alarm trigger is transmitted by the monitoring module 30 to the database server 48 which has been previously programmed to transmit a notification event to the user's pager via the cellular transmitter 44. As the contact sensor is tripped, the camera 34 takes a picture of the front door and transmits that picture via the monitoring module 30 via the global computer network 16 to the database server 48. The user, having been notified via the pager 42, can now access the web server 46 of the server component 14 via his Internet browser 26 to retrieve the photograph that has been stored on a database server 48. In this way, the user can determine whether an intruder has entered via the front door of his vacation home or whether his family has just arrived for their vacation.

Another use for the system 10 would be for the user located at the node 18 to be able to control his lamp 42 at his vacation home located at node 20. The user would contact the web server 46 via his Internet browser 26 to access the database entry of the light switch 41. A virtual representation of the light switch 41 would be available on the web server 46 and could be manipulated by the user to remotely change the state of the light switch 41 and the connected lamp 46, say from being “off” to being “on.” To do this, the user would simply manipulate the on/off virtual representation of the light switch on the web server 46 and this command would be placed in a queue of waiting commands on the server component.

Periodically, the controlling module or monitor 30 polls the server component 14 looking for waiting commands, such as the change state command of the light switch 41. Thereafter, the command would be transmitted to the monitoring device 30 which would instruct the light switch to change from the “off” state to “on” state, and, thus, turning on the lamp 46. This change in state of the lamp 46 could be viewed by an appropriately positioned camera, such as camera 34, which would be used to visually monitor the remote location 20 to determine whether the command had been completed successfully.

Because the present system can accommodate many different connected devices 32 which are capable of generating large amounts of data, such as digital photographs and streaming video, it should be apparent that large amounts of data may be sent over the global computer network 16. This problem is compounded by the fact that there can be hundreds or thousands of clients 12 connected simultaneously to the server 14, each vying for bandwidth. In addition, as described in the Background of the Invention, the TCP protocol is a “greedy” algorithm and that the TCP congestion window does not always allocate bandwidth efficiently. In addition, the TCP congestion window is not able to factor in and account for any previous and/or expected knowledge regarding the client who is sending data, the server who is receiving and processing that data, application-level knowledge and other characteristics of the network. In other words, TCP is not capable of effectively managing, throttling, and adaptively modifying the data rates of the system.

In the present system, however, the identity of the clients and the clients' usage patterns are known and can be recorded and tracked by the server and/or ISP because all of the clients must be registered with the server and/or ISP. In addition, since the clients communicate solely with the servers and via the ISP, it is also possible to track and take into account the load on the servers, the servers' processing load, and the ISP's network traffic. Additionally, it is also possible to keep track of the network status of the global computer network and factor the congestion of the network into this scheme. In this way, the present system can draw on its knowledge of the client, the client's applications and data generators, the server, and the network to more efficiently allocate and control the amount of data sent between the client and the server.

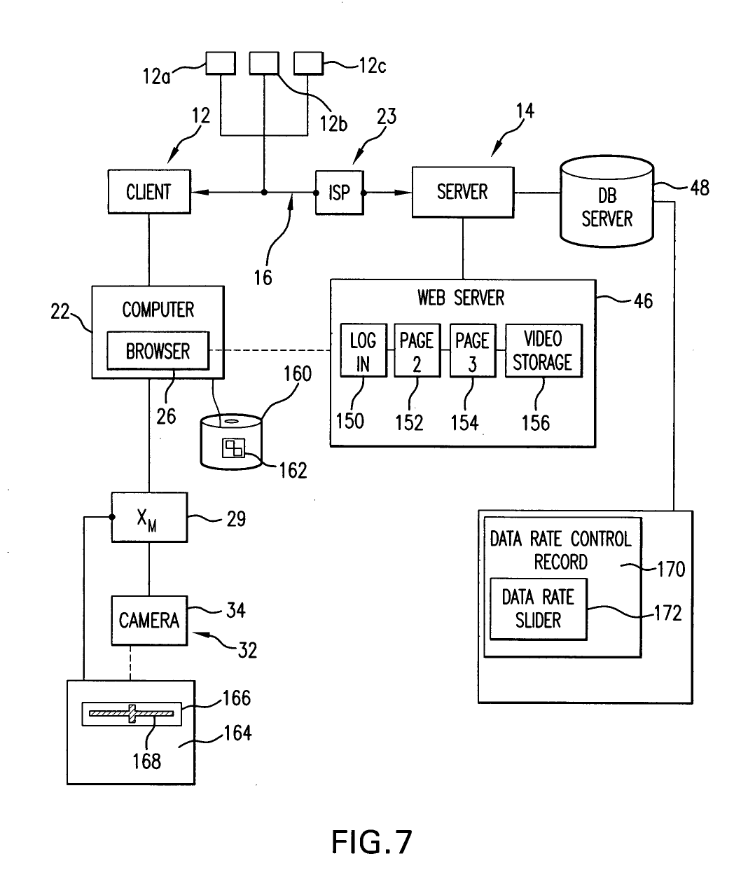

In FIG. 7, a simplified schematic of a client-server system in accordance with the present invention is illustrated. A client 12 is connected to a server 14 via the global computer network 16. In addition, other clients 12a, 12b, 12c may also be connected to the server 14 via the global computer network 16. Each of the clients 12-12c typically includes a computer 22 that is networked to the global computer network 16 via an ISP 23. The client 12 also has a world wide web Internet browser 26 for displaying web pages 50. In addition, a local storage device 160, such as a hard drive, is typically present for storing digital data. One such type of data is a digital video file 162 which is typically many megabytes in size.

The present invention also contemplates that a monitoring appliance 29 is attached to the client computer 22. A plurality of connected devices and data generators 32 are connected to the monitoring appliance 29 as described in greater detail above. One of those data generating devices is video camera 34 that is capable of capturing, recording and broadcasting/streaming digital video over the global computer network 16. The monitoring appliance 29 also includes an interface 164 which includes a control 168 for controlling the data send rate of the client.

As described in greater detail above, the server 14 would typically include a web server 46 that is capable of serving up web pages to the client browser 26 as requested and a database server 48. The data rate control 164 is stored as a virtual representation or record 170 in the database server 48, as is the slider control 172.

Each client 12 must register with the server 14 before such services could be used. Because each client 12 is registered with the server 14, its identity is known and its usage patterns may be tracked. In addition, the user 12 must also log onto the ISP to obtain access to the global computer network 16.

To effect the registration with the server 14, the client 12 typically visits the login page 150 residing on the web server 46 and enters its appropriate login identification and password. Once the client 12 is logged into the system, he can access the other pages 152, 154, 156 that reside on the web server 46. In the present embodiment depicted in FIG. 7, it is assumed that the user must first visit pages 152 and 154 before page 156 can be visited.

In operation, the client 12 using his web browser 26, would login to the server 14 by accessing the login page 150 residing on the web server 46. Thereafter, the client 12 would visit the introductory pages 152 and 154, before the client eventually arrived at the video storage page 156. Once the client 12 reaches the video storage page 156, he would then be permitted to upload a video file such as the video file 162 stored on the local hard drive 160 or the video file that is being broadcasted by the connected camera 34.

It should be understood that users 12a, 12b and 12c are also permitted to perform similar functions and interactions with the server 14 as described in connection with client 12. For example, client 12a may want to access and download the video file stored on the server by client 12a.

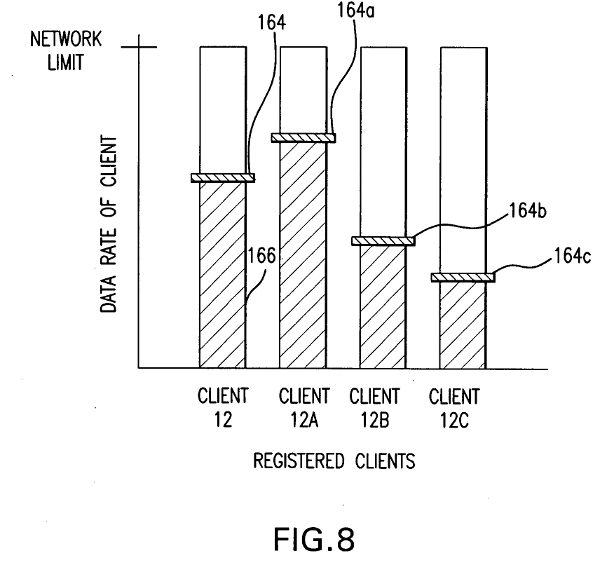

In FIG. 8, there is shown a graph of the theoretical maximum data rates of each of the registered clients 12, 12a, 12b and 12c. The bars depicted in FIG. 8 and associated with each respective client represent the theoretical maximum data rate allowed over the global computer network 16.

It is contemplated, however, that the data rate for each client may be limited by the client server 12, server 14, or ISP 23. Such a data rate limit is depicted in FIG. 8 as a bar 164, 164a, 164b and 164c respectively for each client. These upper-end data limits on the data rate are set by the server 14 to manage the network congestion to avoid overloading the network. In this way, the server 14 or ISP 23 is able to pro-actively set the data rate 166 of a client 12 using its knowledge of the client, itself, and the network conditions.

For example, the server 14 could control the amount of data it receives from the client 12 by sending data rate control information to the client in the form of an upper end limit 164. When the client 12 receives this data rate limit 164, it would tailor its data send rate to fit under that limit.

One way the server could control the data rate would be by adjusting the data rate control 172 of the monitoring module 29. Since a virtual representation of the slider control 172 is stored on the database server 48, the server can force the client 12 to conform to the upper end data limit 164 by imposing a maximum data rate on the control and updating the slider control 168 to conform to this limit.

For example, suppose the client was sending streaming video from camera 34 at a frame rate of 30 fps, a size of 160×320 pixels to the video storage site 156 and at a data rate of 10 MB/min. If the server 14 wanted to limit the client's data rate to 1 MB/min, the server would update the data slider's record 172 in its database 48 to a maximum data rate of 1 MB/min. When the slider control 168 is synchronized with the record 172, the client would then be constrained to a maximum digital video transfer rate of 1 MB/min.

The client could respond to this change in maximum data rate by lowering the frame rate of the video (to say 15 fps) or decreasing the size of the video picture (to say 80×160 pixels) in order to comply with this newly set limit. Additionally, the client could also choose to skip or drop certain frames of the video in order to comply with the data rate limit 164 imposed by the server 14.

Using another example, assuming the client was sending digital pictures to the server 14 and it needed to lower its data send rate, it could lower the resolution and/or the color depth of the photograph being sent to the server in order to meet the constraints imposed by the server 14.

Using another example, the client computers 12, 12a, 12b, 12c transmit data over the global computer network 16 to server 14 via ISP 23. Each client 12-12c includes a data rate control 164 which is controllable by the ISP 23. Once the ISP 23 begins to detect an unacceptably large quantity of dropped packets in their system due to an over-utilization of bandwidth from the client's 12a-c, the ISP 23 can choose to limit to the data rate of the clients 12a-c by sending a limit to each of the client's data rate controls 164. This data rate imposed could be different for each client.

Similarly, if the ISP 23 or server 14 is expecting to receive a large quantity of data from the clients at noon based on previous user usage patterns, the ISP 23 or server 14 could proactively send out lower data rate limits to each client to avoid network congestion.

In determining and setting the upper data limit for each of the clients 12, the server can take into account any combination of the following criteria:

1. The likelihood that a client will send or receive a large amount of data. For example, if the client is not presently logged into the web site, then it is unlikely that the server 14 will be receiving or sending much data from the client or from a device under the client's control, such as a video camera. As such, the client's data rate limit can be set lower. Similarly, if the client has logged into the system by entering the appropriate data on the login page 150, the likelihood that he may be sending or receiving data into the system is increased and its data rate limit 164 would likewise be increased.

2. The available bandwidth of the global computer network. For example, if many users logged onto the server 14 and/or ISP 23 generally using the global computer network 16, the available bandwidth of the global computer network would likely be affected. In the case where many users are logged into the global computer network and the available bandwidth is lower, the server 14 or ISP 23 could issue a lower data rate limit to each client to reduce the network congestion.

3. The closeness of the client to the part of the web site concerning a large data source. For example, once a client 12 has logged into the system, and travels closer to the video storage page 156 by accessing introductory pages 152 and 154, this client's data limit rate could be increased by the server in anticipation of receiving a large volume of data in the form of a digital video file 162 being transmitted to the video storage page 156.

4. The data rate purchased by the client. For example, if a subscription fee was being charged to access the server 14, it would be possible to allocate different data limits to different clients depending on the amount of bandwidth purchased by the client.

5. The ability of the server to process the data. For example, if many clients were logged onto the server 14 and using a large portion of the processing power of the server 14, the data rate limit of each client could be reduced to alleviate some of this burden so as not to overload the processing power of the server 14.

6. Client usage patterns. For example, if a particular client 12 has logged in at noon consistently during the past week, it is likely that this particular client will be logging on again today at noon and transmitting data. In such an instance, this particular client's data rate could be pro-actively increased at noon in anticipation that it will again log on and transmit data. Similarly, if clients located on the east coast of the United States do not log on to the server 14 during normal sleeping hours, i.e., between 12:00 a.m. and 7:00 a.m., the data rate limit from those clients could be reduced since it is unlikely that data would be sent by them during this time.

It should also be understood that other quality of service issues may also be factored into the above-mentioned scheme to allow the server 14 to modify the data rate. In addition, other criteria similar to those set-forth above are contemplated and could be employed as part of the present invention.

It is contemplated that all or some of the aforementioned criteria would be used in any conventional algorithm, such as a statistical averaging scheme which accounts for each of the criteria proportional to their importance and effect on the network congestion, to control network traffic. In this way, the method of the present invention for controlling the data rate is responsive and pro-active, instead of being limited to responding to only past conditions, as is the case with the TCP congestion window scheme.

In the present invention, the data rate for each client can be controlled by the server 14 or the ISP 23 instead of simply allowing the clients to send as much data as possible and simply dropping any excess as is the case with conventional methods of controlling network congestion on the global computer network, such as the case with TCP.

The pro-active data rate control of the present invention is performed in response to any number of conditions which do not necessarily relate to the network traffic itself. Such a system eliminates latent data rate ramp-up times and allows the server to more accurately prevent network and server congestion. The utilization of outside characteristics of the client, network and server allow for greater control because more knowledge about access patterns means that the server knows more about what is actually going on from a data rate perspective. The server is also allowed to manage the processing limits that it is constrained by as it relates to its ability to process the data received by the client while still giving the clients realistic limits on their data rates.

Because the data rate limits are communicable to the client, the client is able to make decisions about what type and amount of data it wishes to send under the imposed conditions. For example, if the client's data rate has been set low by the server, then the client may choose to send the video at a slower frame rate or use fewer colors in their digital photographs.

Using the present invention, a server or ISP could know at any given time how much data is coming in and can proportion out the processing power based on a pre-selected priority scheme. In contrast, traditional or conventional methods for controlling network congestion typically focus on ways of solving congestion problems once they have been detected as opposed to taking steps to prevent congestion before it happens.

While certain preferred embodiments and various modifications thereto have been described or suggested, other changes in these preferred embodiments will occur to those of ordinary skill in the art which do not depart from the broad inventive concepts of the present invention. Accordingly, reference should be made to the appended claims rather than the specific embodiment of the foregoing specification to ascertain the full scope of the present invention.

What is claimed is:

1. A method of adaptively controlling resource behavior comprising the steps of:
(a) providing a resource having at least one parameter and at least one attribute;
(b) providing a first controller in communication with the resource for receiving parameters and an attribute;
(c) generating at least one output attribute corresponding to the first resource parameters;
(d) communicating the output attribute to the resource;
(e) updating one of the at least one parameter of the resource;
whereby, the behavior of the first resource is modified in regard to the updated parameter.

2. The method according to claim 1, wherein the attribute received by the controller comes from the resource.

3. The method according to claim 1, wherein the attribute received by the controller is external to the resource.

4. The method according to claim 1, wherein the resource has a user interface corresponding at least in part to the resource parameter and output attribute.

5. The method according to claim 4, wherein the user interface is updated when the resource is updated.

6. The method according to claim 1, wherein the resource is a plurality of resources and the controller controls each of the resources.

7. The method according to claim 1, wherein the resource is a plurality of resources and wherein there is a plurality of the controllers, each associated with at least one of the resources.

8. The method according to claim 1, wherein the resource and the controller communicate over the global computer network.

9. The method according to claim 1, wherein the resource is a data rate of a client on a computer network.

10. The method according to claim 9, wherein the controller is part of a server on the computer network.

11. An adaptively controlled resource comprising:
a device having at least one parameter and at least one attribute corresponding to a device behavior;
a controller in communication with the device for receiving an at least one parameter and one input attribute;
a processor for generating at least one output attribute based at least in part on an inputted attribute and communicating said output attribute to the device, wherein one of the at least one device parameter is updated and the device behavior is updated in regard thereto.

12. The adaptively controlled resource according to claim 11, wherein the attribute received by the controller comes from the resource.

13. The adaptively controlled resource according to claim 11, wherein the attribute received by the controller is external to the resource.

14. The adaptively controlled resource according to claim 11, wherein the resource has a user interface corresponding at least in part to the resource parameter and output attribute.

15. The adaptively controlled resource according to claim 14, wherein the user interface is updated when the resource is updated.

16. The adaptively controlled resource according to claim 11, wherein the resource is a plurality of resources and the controller controls each of the resources.

17. The adaptively controlled resource according to claim 11, wherein the resource is a plurality of resources and wherein there is a plurality of the controllers, each associated with at least one of the resources.

18. The adaptively controlled resource according to claim 11, wherein the resource and the controller communicate over the global computer network.

19. The adaptively controlled resource according to claim 11, wherein the resource is a data rate of a client on a computer network.

20. The adaptively controlled resource according to claim 19, wherein the controller is part of a server on the computer network.

21. An intelligent network device comprising:
an adaptively controlled resource having at least one parameter and at least one attribute corresponding to a behavior of the network device;
a controller in communication with the device for receiving an at least one parameter and one input attribute; and
a processor for generating at least one output attribute based at least in part on resource inputted attribute and communicating the output attribute to the device, wherein one of the at least one device parameter is updated and the resource behavior is updated in regard thereto.

22. The intelligent network device in claim 21 wherein said resource is a computer program.

23. The intelligent network device of claim 21 wherein said resource is computer hardware.

24. The intelligent network device of claim 21 wherein said resource is embedded in firmware.

25. The intelligent network device of claim 23 wherein said hardware is an appliance.

26. The intelligent network device of claim 25 wherein said appliance is selected from the group consisting of cameras, radios, smoke detectors, carbon monoxide detectors, water detectors, radon detectors, fire detectors, motion detectors, contact sensors, light switches, thermostats, televisions, television recorders, washers, dryers, microwave ovens, cooking ranges, car alarms, boat alarms, plant watering devices, sprinklers, radio tuners, pagers, cellular telephones, computers and combinations thereof.
